(19) United States
(12) Patent Application Publication
(10) Pub. No.: US 2016/0098578 A1
(43) Pub. Date: Apr. 7, 2016

(54) SYSTEM AND METHOD FOR PERSISTENT DATA INTEGRITY IN DOCUMENT COMMUNICATION

(71) Applicant: NUOFFER, INC., Toluca Lake, CA (US)

(72) Inventor: Kevin Hincker, Los Angeles, CA (US)

(21) Appl. No.: 14/507,215

(22) Filed: Oct. 6, 2014

(51) Int. Cl. G06F 21/64; H04W 12/10; H04L 9/32

(52) U.S. Cl. CPC G06F 21/64; H04L 9/3247; H04W 12/10

(57) ABSTRACT

A system, method, and computer readable medium for verifying data integrity of documents involves adding a machine-readable stamp on a document generated by a device of a first user. The machine-readable stamp allows another user which receives a copy of the document to use another device to verify the integrity of data in the copy.

### FIELD

This invention relates generally to communication of electronic and paper documents and, more particularly, to a system and method for maintaining data integrity during communication of electronic and paper documents.

### BACKGROUND

A typical document passes through multiple electronic signature (eSignature) and document management platforms over the course of its existence. Maintaining security is difficult when an audit trail of this document is not accessible across all the document management platforms, such as DotLoop and Docusign. Maintaining security is also difficult when the document passes between analog domains (e.g., in printed paper form) and digital domains (e.g., an electronic image form).

What is needed is data security technology that persists in a document across multiple document management platforms and across analog and digital domains. Data security technology should capture user-generated materials, such as electronic signatures and/or document specific content.

### SUMMARY

Briefly and in general terms, the present invention is directed to a system, method, and a computer readable medium for communicating document data between client communication devices.

In aspects of the invention, a system comprises a server configured to store an image of a document and configured to add a machine-readable stamp on the image of the document, the document having been generated by a first client communication device. The stamp is visible when the image of the document is viewed, and the stamp includes or encodes a code unique to the document.

The server is further configured to transmit to a second client communication device a response to a request from the second client communication device, wherein the response includes any one or more of: the image of the document, an abstract of document specific content within the document, and a link that enables the second client communication device to retrieve the image of the document.

In aspects of the invention, a method comprises storing an image of a document generated by a first client communication device, the image including document specific content added to the document by the first client communication device.

The method further comprises adding a machine-readable stamp on the image of the document, wherein the stamp is visible when the image of the document is viewed, and the stamp includes or encodes a code unique to the document.

The method further comprises transmitting to a second client communication device a response to a request from the second client communication device. The response includes any one or more of: the image of the document, an abstract of document specific content within the document, and a link that enables the second client communication device to retrieve the image of the document.

In aspects of the invention, a non-transitory computer readable comprises instructions to store an image of a document, the document having been generated by a first client communication device. The image includes document specific content added to the document by the first client communication device.

The computer readable medium further comprises instructions to add a machine-readable stamp on the image of the document. The stamp is visible when the image of the document is viewed and the stamp includes or encodes a code unique to the document; and

The computer readable medium further comprises instructions to transmit to a second client communication device a response to a request from the second client communication device. The response includes any one or more of: the image of the document, an abstract of the document specific content that was added to the document by the first client communication device, and a link that enables the second client communication device to retrieve the image of the document.

The features and advantages of the invention will be more readily understood from the following detailed description which should be read in conjunction with the accompanying drawings.

### BRIEF DESCRIPTION OF THE DRAWINGS

FIG. 1 is a schematic diagram of a system communicating documents with persistent data integrity.

FIGS. 2A-2F are snapshots of exemplary documents communicated in the system of FIG. 1

FIG. 3 is a method for communicating documents of FIGS. 2A-2F.

### DETAILED DESCRIPTION

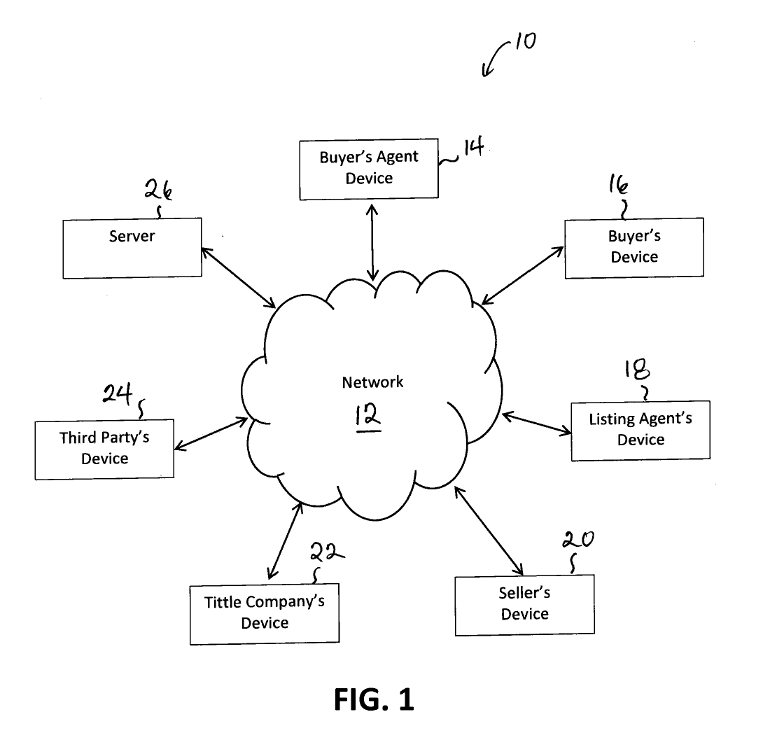

Referring now in more detail to the exemplary drawings for purposes of illustrating aspects of the invention, wherein like reference numerals designate corresponding or like elements among the several views, there is shown in FIG. 1 a diagram of persistent data integrity system 10 including electronic communication devices that communicate through communications network 12. The electronic communication devices include Buyer's Agent device 14, Buyer's device 16, Listing Agent's device 18, Seller's device 20, Title Company's device 22, and Third Party's device 24. In the context of a property purchase transaction, the Third Party can be a bank or escrow entity. The electronic communication devices transmit and receive data, including electronic documents related to a purchase transaction, to and from each other and to and from server 26. Any one or more of the electronic communication devices (14 to 24) can be a client communication device.

Network 12 may comprise one or a combination of communication systems. Communication systems include without limitation the Internet, a metropolitan area network, a wide area network, a local area network, and personal home networks. Communication systems also include telecommunication networks, such as mobile or cellular transmission networks. Communication systems may employ wired and wireless communication protocols, such as Wi-Fi and others.

Communication devices (14 to 24) include without limitation a personal computer, laptop computer, mobile or cellular telephone, tablet, television subscriber console (e.g., a cable box), gaming console, a multifunction peripheral device (e.g., a machine with fax, optical scanning, email, and printing functions), Internet-enabled television, and any device capable of receiving or transmitting a document electronically through network 12. Any one or more of the communication devices (14 to 24) may include one or more microprocessors and memory components (e.g., flash drives, hard drives, optical drives, and RAM drives).

Sever 26 may comprise one or a combination of computers and databases, which can form a collection of microprocessors and memory components (e.g., flash drives, hard drives, optical drives, and RAM drives). When server 26 stores data, such as an image an entire document or document specific content, such data can be stored in memory components of the server and/or any of the communication devices (14 to 24).

Server 26 and one or more of the electronic communications devices (14 to 24) embody persistent data integrity system 10 of the present invention and are used to perform a method for maintaining persistent data integrity in documents communicated in electronic and/or paper form. Persistent data integrity system 10 is enabled by specialized computer software, referred to herein as persistent data integrity (PDI) software, stored and executed on server 26 and one or more of the electronic communications devices. Some modules or components of the PDI software stored and executed on server 26 while other modules or components of the PDI software are stored and executed on one or more of the electronic communications devices. The PDI software can be stored on non-volatile memory components of server 26 and/or the electronic communications devices.

The system and method of the present invention can be used by any one or more people. The persons involved can vary depending on the context of use, and is not limited to the context implied by the labels used in FIG. 1 for the electronic communication devices (14 to 24). In the context of a real estate purchase, the system and method of the present invention can be used by one or more of: a Buyer's Agent, Buyer, Listing Agent, Seller, persons at a Title Company, and persons at a Third Party. The electronic communication devices of FIG. 1 are labeled according to this context. In another context, the labels in FIG. 1 for the electronic communication devices can be modified accordingly.

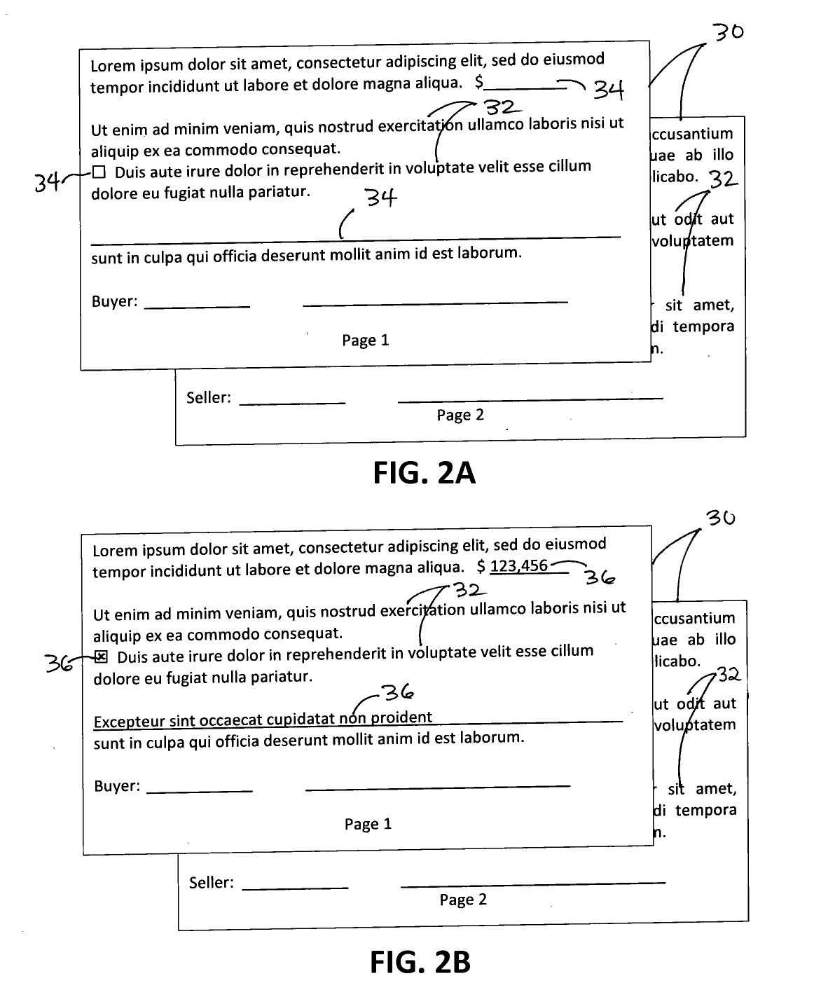

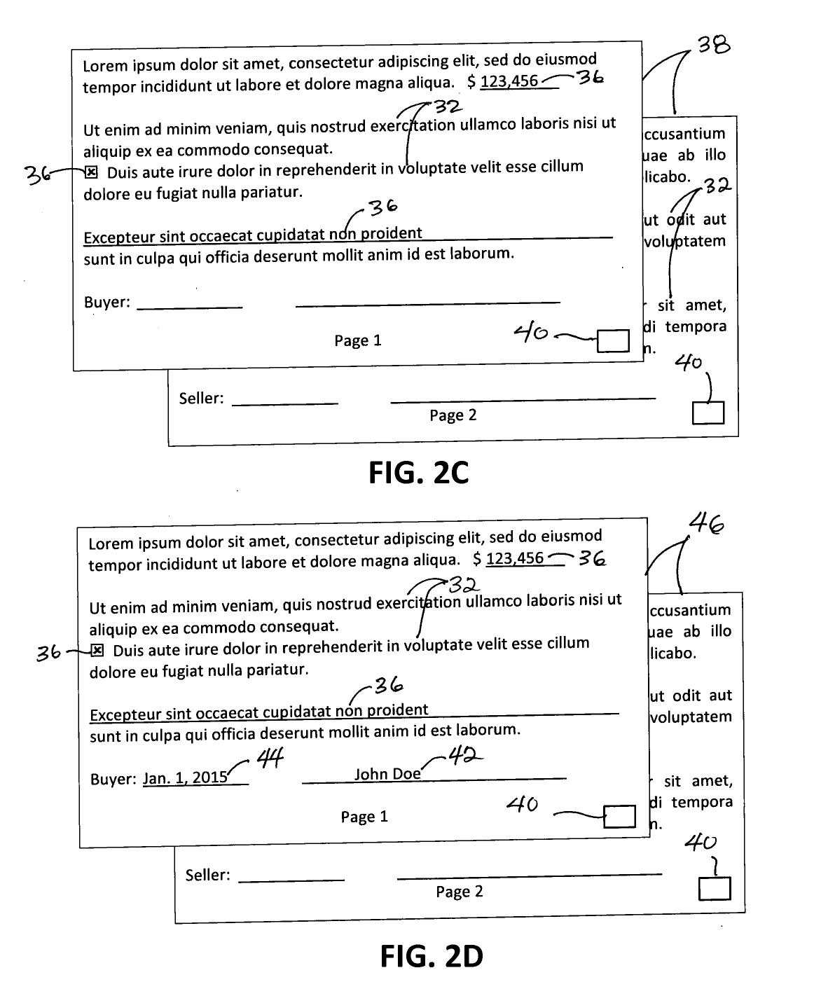

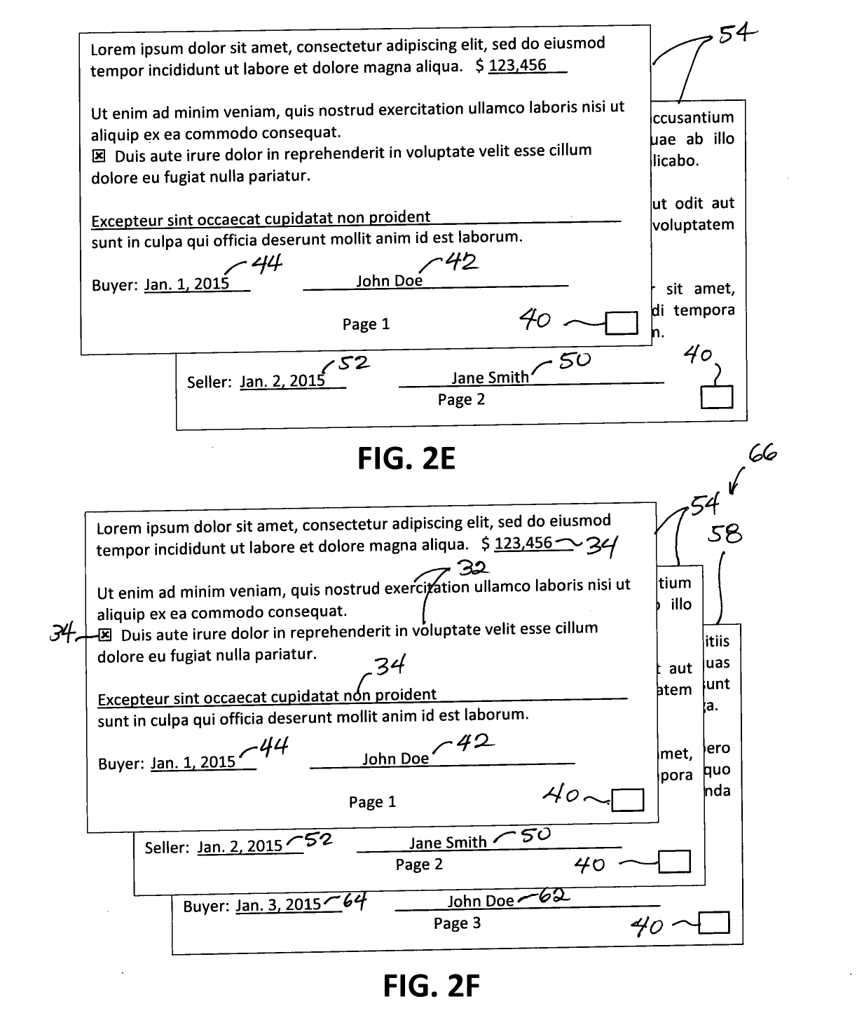

FIGS. 2A-2F show various snapshots of a Purchase Agreement. FIGS. 2A-2F are illustrated with only a few pages as an example and for ease of illustration. When communicated between the various communication devices and server 26, the Purchase Agreement (or any other type of document communicated within system 10) can actually be a single page or more pages than what is illustrated.

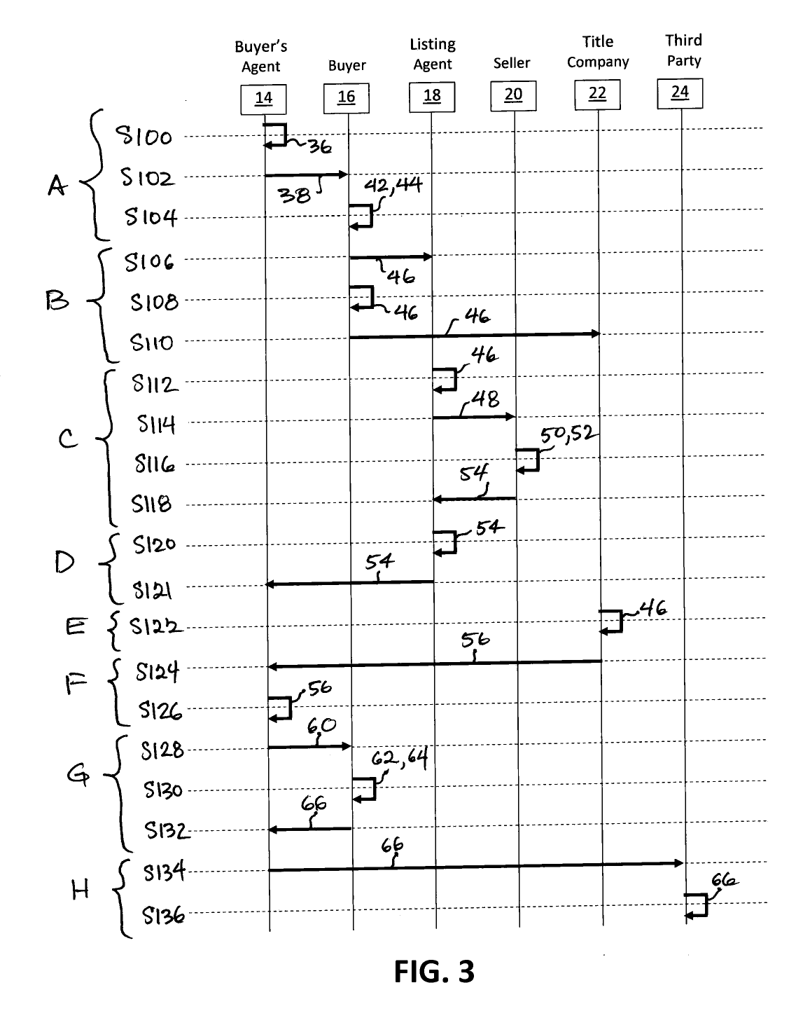

FIG. 3 shows a persistent data integrity method described above in connection with FIGS. 2A-2F. The persistent data integrity method may be limited to Section A of FIG. 3, or the method may comprise Section A and other sections (B to H) in FIG. 3, or the method may be limited any one or more of other sections (B to H) in FIG. 3.

### EXAMPLE A

In an example, a Buyer's Agent and a Buyer may use the persistent data integrity system and method of the present invention as part of a real estate transaction. The method is performed according to Section A in FIG. 3. The Buyer's Agent can be a real estate agent, and the Buyer is a person who is interested in purchasing real estate. In this example, persistent data integrity system 10 may comprise Buyer's Agent device 14 and Buyer's device 16 (and optionally server 26).

At Step S100 of FIG. 3, Buyer's Agent uses device 14, which is executing PDI software, to fill in terms of an initial Purchase Agreement for a property. In this context, the terms (called “transaction terms”) may include without limitation one or a combination of offer price, property address, and due diligence conditions (e.g., a satisfactory inspection of the property and a satisfactory title report on the property). Alternatively, in a property lease context, the transaction terms may include without limitation one or a combination of lease price, lease duration, property address, and renewal options (e.g., rent amount upon renewal of the lease).

The transaction terms entered by the Buyer's Agent, which can be in the form of numerical data and/or text and/or checked boxes, are communicated by Buyer's Agent device 14 to server 26. Sever 26 stores the individual transaction terms in memory. Sever 26 also creates and stores an electronic snapshot of each page of the Purchase Agreement. The snapshot is an electronic image. The electronic image can be in any format, including without limitation BMP (bitmap), GIF (graphics interchange format), JPEG (joint photographics expert group), PDF (portable document format), other open standards, and proprietary formats.

Sever 26 adds a persistent data integrity (PDI) stamp to the snapshot. The PDI stamp is machine-readable and becomes an integral part of the snapshot. For example, the PDI stamp is embedded and fixed in the electronic image data (e.g., embedded in BMP, GIF, JPEG, or PDF data) of the snapshot. The PDI stamp is unique to the document on which the PDI stamp was added. For example, the PDI stamp in a snapshot of one Purchase Agreement will be different from the PDI stamp in snapshots of other Purchase Agreements. In addition or alternatively, the PDI stamp is unique to each page of the document on which the PDI stamp was added. For example, the PDI stamp on the snapshot of the first page of a Purchase Agreement will different from the PDI stamp on the snapshot of the second page of the same Purchase Agreement.

When snapshot 38 (and any subsequent version of the document) is viewed, such as on a computer display screen or on a printed paper copy, the graphic image of the PDI stamp is visible to the user. The PDI stamp enables system 10 to identify the origin and track the history of the Purchase Agreement (or any other type of document communicated within system 10) on which PDI stamp is present. The PDI stamp is a graphic image having a machine readable format. The PDI stamp can include one or a combination of alphanumeric characters and bar codes. Bar codes can be one dimensional or matrix-type (e.g., two dimensional). Alphanumeric characters and/or bar codes of the PDI stamp include or encode a code that is unique to the document (e.g., the Purchase Agreement in this example).

As shown in FIG. 2A, the Purchase Agreement (or any other type of document communicated within system 10) can be a standardized form document 30 with preexisting text 32 and blank spaces 34 for various transaction terms. Preexisting text 32 is static in that it is the same for multiple purchase agreements. Alternatively, the Purchase Agreement (or any other type of document communicated within system 10) is not a standardized form document in that it contains no preexisting text.

Initially, standardized form document 30 has no PDI stamp. Using Buyer's Agent device 14, the Buyer's Agent enters data for transaction terms 36 into blank spaces 34, as shown in FIG. 2B. Data for transaction terms 36 are document specific content which can vary from one purchase agreement to another purchase agreement. Device 14 transmits the data for the transaction terms to server 26 which stores the data into memory. When the Buyer's Agent is finished entering desired transaction terms into the form document, the Buyer's Agent enters a submit command on device 14 which causes server 26 to create and store snapshot 38 (i.e., an electronic image file) of the entire form document. The submit command includes the intended recipient of snapshot 38, which is the Buyer in this example.

As shown in FIG. 2C, snapshot 38 includes preexisting text 32 and specific transaction terms 36 that were entered by Buyer's Agent. Server 26 has embedded PDI stamps 40 into every page of snapshot 38. PDI stamp 40 on this particular document would be different from the PDI stamp in other documents which the Buyer's Agent may have prepared previously or will prepare in the future. Optionally, PDI stamp 40 on page 1 of on this document can be different from PDI stamp 40 on page 2.

Server 26 also stores metadata related to the submit command from Buyer's Agent device 14. Such metadata (called “submission metadata”) include without limitation one or a combination of the date and time of submission, IP address of Buyer's Agent device 14, and the recipient information (e.g., name of the person, email address of the person, etc.) in the Buyer's submit command. Server 26 associates document snapshot 38 with the submission metadata. Server 26 optionally associates particular PDI stamps 40 on document snapshot 38 with the submission metadata. The association can be accomplished with a lookup table or similar data structure maintained by server 26 and stored in memory.

At Step S102 of FIG. 3, document snapshot 38 of FIG. 2C is transmitted by server 26 through network 12 to Buyer's device 16. For example, snapshot 38 can be transmitted by server 26 as an attachment in an email or other type of electronic message to the Buyer's email address, mobile telephone number, or other type of messaging account registered to the Buyer. Alternatively, server 26 sends an email or other type of electronic message which contains a link to snapshot 38. The link can be a web address or a hyperlink that encodes a web address. For example, the link can be a uniform resource locator (URL) that is unique to document snapshot 38. There can be one URL for the entire snapshot 38 or multiple URLs for various pages of snapshot 38.

The Buyer can use Buyer's device 16 to access the Buyer's account and retrieve snapshot 38. PDI stamps 40 on snapshot 36 allow Buyer's device 16 to recognize snapshot 38 as being the correct document and/or authenticate snapshot 38 as having come from the Buyer's Agent. Recognition and/or authentication can be performed by one or more modules of the PDI software (executed on server 26 and/or Buyer's device 16) which processes the PDI stamps and the submission metadata. For example, the PDI software can cause server 26 to transmit to Buyer's device 16 the specific values (e.g., numbers, text, and/or check marks) for transaction terms which should appear on unsigned document snapshot 38 received by the Buyer. The PDI software optionally causes Buyer's device 16 to display those values to allow the Buyer to make a visual comparison with the document snapshot 36 which she has obtained. Those values can be displayed as part of an abstract of document specific content in addition to or as an alternative to displaying the entire document. As used herein an “abstract” of a document is a brief summary of the document that includes document specific content (e.g., transaction terms). The abstract may exclude an image (snapshot) of the entire document and/or exclude preexisting text of the document (e.g., preexisting text of a standardized form document).

At Step S104 of FIG. 3, after the Buyer reads the information in snapshot 38 and confirms that transaction terms 36 are correct, the Buyer applies electronic signature 42 and optionally additional data, such as date 44, to snapshot 38. Electronic signature 42 and any other data are applied by the Buyer to snapshot 38 using Buyer's device 16 executing persistent data integrity (PDI) software. This creates buyer-signed document shapshot 46 which Buyer's device 16 transmits to server 26.

Referring to FIG. 2D, buyer-signed document shapshot 46 is stored by server 26 in memory. Embedded within buyer-signed document shapshot 46 are preexisting text 32, transaction terms 36, PDI stamps 40, the Buyer's electronic signature 42, and other data 44 (if any) applied by the Buyer. PDI stamps 40 in buyer-signed document shapshot 46 are the same as in unsigned document snapshot 38 of FIG. 2C.

Server 26 stores metadata (called “registration metadata”) generated with application of electronic signature 42. Server 26 associates buyer-signed document snapshot 46 with the stored registration metadata. Server 26 associates the particular PDI stamps 40 of buyer-signed document snapshot 46 with the stored registration metadata. The association can be accomplished with a lookup table or similar data structure maintained by server 26 and stored in memory.

Registration metadata include without limitation any one or a combination of the date and time of signing, IP address of Buyer's device 16, geo location data obtained from Buyer's device 16, and Buyer identification data. Buyer identification data includes without limitation an electronic photograph, video, and/or biometric data (such as fingerprint data) of the Buyer obtained by Buyer's device 16 immediately before, at the time of, immediate after, or as part of the process of applying the Buyer's electronic signature 42.

In Example A, Buyer's Agent device 14 can be a first client communication device that generates a document (e.g., a Purchase Agreement), and Buyer's Agent device 14 has added document specific content (e.g., transaction terms) to the document. Buyer's device 16 can be a second client communication device that receives from server 26 a response that includes any one or more of: the image of the document, an abstract of document specific content that was added to the document by the first client communication device, and a link that enables the second client communication device to retrieve the image of the document.

### EXAMPLE B

In an example, the Buyer may use the persistent data integrity system and method of the present invention. The method is performed according to Section B in FIG. 3. In this example, persistent data integrity system 10 may comprise Buyer's device 18 (and optionally other communication devices and/or server 26).

Section B may continue from Section A of FIG. 3. At Step S106 in Section B, buyer-signed document snapshot 46 of FIG. 2D is transmitted by server 26 and/or Buyer's device 18 through network 12 to Listing Agent's device 18. For example, buyer-signed document snapshot 46 can be transmitted by server 26 and/or Buyer's device 18 as an attachment in an email or other type of electronic message to the Listing Agent's email address, mobile telephone number, or other type of messaging account registered to the Listing Agent. Alternatively, server 26 and/or Buyer's device 18 sends an email or other type of electronic message which contains a link to buyer-signed document snapshot 46. The link can be a web address or a hyperlink that encodes a web address. For example, the link can be a uniform resource locator (URL) that is unique to buyer-signed document snapshot 46. There can be one URL for the entire buyer-signed document snapshot 46 or multiple URLs for various pages of buyer-signed document snapshot 46.

The Listing Agent can use Listing Agent's device 18 to access the Listing Agent's account and retrieve buyer-signed document snapshot 46. PDI stamps 40 on buyer-signed document snapshot 46, submission metadata, and/or registration metadata allow Listing Agent's device 18 to recognize the buyer-signed document as being the correct document and/or authenticate the buyer-signed document as having come from the Buyer and Buyer's Agent. Recognition and/or authentication can be performed by one or more modules of the PDI software (executed on server 26 and/or Listing Agent's device 18) which process the PDI stamps and/or submission metadata and/or registration metadata. For example, the Listing Agent may review transaction terms 36 by viewing the document either as an electronic image on Listing Agent's device 18 or as a printed paper copy of the document. For example, the PDI software can cause server 26 to transmit to Listing Agent's device 18 the specific values (e.g., numbers, text, and/or check marks) for transaction terms which should appear on buyer-signed document snapshot 46 received by the Listing Agent. The PDI software optionally causes Listing Agent's device 18 to display those values to allow the Listing Agent to make a visual comparison. Those values can be displayed as part of an abstract of document specific content in addition to or as an alternative to displaying the entire document.

In another example for verifying data integrity, server 26 can look up the code in the PDI stamp of the document in question (e.g., buyer-signed document snapshot 46 in this Example) and tries to match it to a code of another PDI stamp that was previously stored by server 26 into memory. If a match is made, Listing Agent's device 18 receives from server 26 a response that would allow the Listing Agent to verify the integrity of buyer-signed document snapshot 46 that he has received. The response from the server can include any of the image of the particular document associated with the PDI stamp code that was previously stored by server 26, an abstract of document specific content in that particular document, and a link that enables the Listing Agent's device 18 to retrieve the image of that particular document.

Alternatively or additionally, as shown at Step S108 in FIG. 3, buyer-signed document snapshot 46 of FIG. 2D is transmitted by server 26 through network 12 to Buyer's device 16 in the manner (by embedding or link) described above for Listing Agent's device 18. This allows the Buyer to retain a copy of the document signed by the Buyer.

Alternatively or additionally, as shown at Step S110 in FIG. 3, buyer-signed document snapshot 46 of FIG. 2D is transmitted by server 26 and/or Buyer's device 16 through network 12 to Title Company device 22 in the manner (by embedding or link) described above for Listing Agent's device 18. This allows the Title Company to prepare a title report on the property specified in buyer-signed document snapshot 46.

Alternatively or additionally, buyer-signed document snapshot 46 of FIG. 2D is transmitted by server 26 and/or Buyer's device 16 through network 12 to Buyer's Agent device 14 in the manner (by embedding or link) described above for Listing Agent's device 18. This allows the Buyer's Agent to retain a copy of the document signed by the Buyer. PDI stamps 40 on buyer-signed document snapshot 46 and/or registration metadata allow Buyer's Agent device 14 to recognize the buyer-signed document as being the correct document and/or authenticate the buyer-signed document as having come from the Buyer. Recognition and/or authentication can be performed by one or more modules of the PDI software (executed on server 26 and/or Buyer's Agent device 14) which process the PDI stamps and/or registration metadata data. For example, the PDI software can cause server 26 to transmit to Buyer's Agent device 14 the specific values (e.g., numbers, text, and/or check marks) for transaction terms which should appear on buyer-signed document snapshot 46 received by the Buyer's Agent. The PDI software optionally causes Buyer's Agent device 14 to display those values to allow the Buyer's Agent to make a visual comparison. Those values can be displayed as part of an abstract of document specific content in addition to or as an alternative to displaying the entire document.

### EXAMPLE C

In an example, the Listing Agent and the Seller may use the persistent data integrity system and method of the present invention. The method is performed according to Section C in FIG. 3. In this example, persistent data integrity system 10 may comprise Listing Agent's device 18 and Seller's device 20 (and optionally server 26).

Section C may continue from Section B of FIG. 3. In Section C, the Listing Agent may review transaction terms 36 by viewing the buyer-signed document as either as an electronic image displayed on Listing Agent's device 18 or as a printed paper copy of the buyer-signed document. Printed paper copy 48 can be generated by Listing Agent's device 18 (via a printer machine communicatively coupled to Listing Agent's device 18) generated at Step S112 in FIG. 3. Printed paper copy 48 is identical to buyer-signed document snapshot 46 of FIG. 2D which was previously stored by server 26. Printed paper copy 48 has the same PDI stamps 40 as buyer-signed document snapshot 46.

Printed paper copy 48 does not contain any metadata on it. At Step S114 in FIG. 3, the Listing Agent provides printed paper copy 48 to the Seller. Although the Listing Agent may vouch for the authenticity of printed paper copy 48, the Seller can independently verify that printed paper copy 48 is authentic. PDI stamps 40 on printed paper copy 48 allows the Seller to verify the authenticity of printed paper copy 48. Optical Character Recognition (OCR) software, such as an OCR mobile application, executed on Seller's device 20 can be used to scan PDI stamps 40 on printed paper copy 48. The OCR software controls an optical scanner communicatively coupled to or an electronic camera on Seller's device 20 to scan the PDI stamps 40. The OCR software can be a module of the PDI software. Alternatively, the OCR software can be separate from the PDI software, and may be obtained by the Seller from a software retailer. Examples of OCR software include commercially available barcode reader software and mobile applications. PDI stamps 40 may have encoded in them one or more internet links (e.g., a URL) for downloading copies of buyer-signed document snapshot 46 from server 26. Scanning of PDI stamps 40 on printed paper copy 48 allows Seller's device 20 to obtain the internet link from each PDI stamp 40 and then download a copy of each page of buyer-signed document snapshot 46. This allows the Seller to compare the printed paper copy 48 with buyer-signed document snapshot 46. This method of document verification, by optically scanning PDI stamps 40 on the surface of a printed copy of a document, is called “resurfacing.” Resurfacing can be performed by Seller using Seller's device 20 and also by Listing Agent using Listing Agent's device 18. Resurfacing using Seller's device 20 is illustrated at Step S116 in FIG. 3.

After the Seller has verified the authenticity of printed paper copy 48 and agrees to transaction terms 36 which appear on printed paper copy 48, the Seller can manually sign the printed paper copy with pen ink. The printed paper copy which is signed by the Seller includes the Sellers ink signature 50 and date 52. The printed paper copy signed by the Seller is called the seller-signed document. At Step S118 in FIG. 3, the Seller gives the seller-signed document (in printed paper form) to the Listing Agent. The seller-signed document (in printed paper form) includes the same PDI stamps as in buyer-signed document snapshot 46 of FIG. 2D.

In Example C, Listing Agent's device 18 can be a second client communication device that receives from server 26 a response that includes any one or more of: the image of the document (e.g., the buyer-signed document in this example), an abstract of document specific content that was added to the document by a first client communication device (e.g., Buyer's Agent device and/or the Buyer's device in this example), and a link that enables the second client communication device to retrieve the image of the document.

### EXAMPLE D

In an example, the Listing Agent uses the persistent data integrity system and method of the present invention. The method is performed according to Section D in FIG. 3. In this example, persistent data integrity system 10 may comprise Listing Agent's device 18 and Buyer's Agent device 14 (and optionally server 26).

Section D may continue from Section C of FIG. 3. At Step S120 in Section D, an electronic copy of seller-signed document (called the “seller-signed document snapshot 54) can be created by feeding the original seller-signed document (in printed paper form) into an optical scanning device that is communicatively coupled to or is an integral part of Listing Agent device 18. The electronic copy is an electronic image in any format, including without limitation BMP, GIF, JPEG, PDF, other open standards, and proprietary formats. The electronic copy of seller-signed document 54 includes the same PDI stamps as in buyer-signed document snapshot 46 of FIG. 2D.

At Step S121 of FIG. 3, the Listing Agent can use Listing Agent device 18 to forward seller-signed document snapshot 54 to the Buyer's Agent. This can be accomplished by attaching seller-signed document snapshot 54 (e.g., an image file in any format such as BMP, GIF, etc.) to an email or other type of electronic message to the Listing Agent's email address, mobile telephone number, or other type of messaging account registered to the Buyer. Alternatively, Listing Agent device 18 may transmit seller-signed document snapshot 54 to server 26, then server 26 stores seller-signed document snapshot 54 in memory, and then server 26 sends an email or other type of electronic message which contains a link to seller-signed document snapshot 54. The link can be a web address or a hyperlink that encodes a web address. For example, the link can be a uniform resource locator (URL) that is unique to seller-signed document snapshot 54 stored in memory by server 26. There can be one URL for the entire snapshot 38 or multiple URLs for various pages of seller-signed document snapshot 54.

Buyer's Agent uses Buyer's Agent device 14 to retrieve seller-signed document snapshot 54 from an email or other type of electronic message (when the snapshot of seller-signed document 54 is attached by Listing Agent device 18 to the email or other type electronic message) or from server 26 (when the snapshot of seller-signed document 54 was transmitted by Listing Agent device 18 to server 26).

PDI stamps 40 on seller-signed document snapshot 54 allow Buyer's Agent device 14 to recognize the seller-signed document as being the correct document and/or authenticate the transaction terms in the seller-signed document as being the same as the transaction terms which the Buyer's Agent previously entered. Recognition and/or authentication can be performed by one or more modules of the PDI software (executed on server 26 and/or Buyer's Agent device 14) which processes the PDI stamps. For example, the PDI software can cause server 26 to transmit to Buyer's Agent device 14 the specific values (e.g., numbers, text, and/or check marks) for transaction terms which should appear on seller-signed document snapshot 54 received by the Buyer's Agent. The PDI software optionally causes Buyer's Agent device 14 to display those values to allow the Buyer's Agent to make a visual comparison with seller-signed document snapshot 54 which he has obtained. Those values can be displayed as part of an abstract of document specific content in addition to or as an alternative to displaying the entire document.

Alternatively, the Listing Agent or Seller can use a facsimile (fax) machine to forward the seller-signed document (in paper form) to the Buyer's Agent. This can be accomplished by feeding the original seller-signed document 54 into a transmitting fax machine which then sends image data to a receiving fax machine. The receiving fax machine prints a fax paper copy of seller-signed document 54 which is obtained by the Buyer's Agent. PDI stamps 40 on the fax paper copy allows Buyer's Agent device 14 to recognize the seller-signed document as being the correct document and/or authenticate the transaction terms in the seller-signed document as being the same as the transaction terms which the Buyer's Agent previously entered.

Recognition and/or authentication of the fax paper copy can be performed by resurfacing. OCR software on Listing Agent device 18 can be used to scan PDI stamps 40 on the fax paper copy of the seller-signed document. The OCR software controls a scanner machine communicatively coupled to Listing agent device 18 or an electronic camera on Listing Agent device 18 to scan the PDI stamps 40 on the fax paper copy. The OCR software extracts web links (e.g., a URLs) encoded in PDI stamps 40 and uses the links to view (or download) buyer-signed document snapshot 46 from server 26. This allows the recipient (the Buyer's Agent in this example) to compare the fax paper copy with the buyer-signed document snapshot 46 and to confirm that transaction terms are the same on both documents. Afterwards, the fax paper copy can be imported into system 10 by feeding the fax paper copy into a scanner machine communicatively coupled to the recipient's communication device (Buyer's Agent device 14 in this example), which is communicatively coupled to server 26. The scan of the fax paper copy is stored in memory by server 26 as seller-signed document snapshot 54.

### EXAMPLE E

In an example, the Title Company uses the persistent data integrity system and method of the present invention. The method is performed according to Section E in FIG. 3. In this example, persistent data integrity system 10 may comprise Title Company device 22 and Buyer's Agent device 14 (and optionally server 26).

Section E may continue from Section B or D of FIG. 3. In Section B, buyer-signed document snapshot 46 of FIG. 2D was transmitted by server 26 through network 12 to Title Company device 22 to allow Title Company to check title information of property specified in buyer-signed document snapshot 46. At Step S122 in Section E, PDI stamps 40 on buyer-signed document snapshot 46, submission metadata, and/or registration metadata allow Title Company device 22 to recognize the buyer-signed document as being the correct document and/or authenticate the buyer-signed document as having come from the Buyer and Buyer's Agent. Recognition and/or authentication can be performed by one or more modules of the PDI software (executed on server 26 and/or Title Company device 22) which process the PDI stamps and/or submission metadata and/or registration metadata. For example, the PDI software can cause server 26 to transmit to Title Company device 22 the specific values (e.g., numbers, property address, etc.) for transaction terms which should appear on the buyer-signed document snapshot. The PDI software optionally causes Title Company device 22 to display those values to allow the Title Company to make a visual comparison. Those values can be displayed as part of an abstract of document specific content in addition to or as an alternative to displaying the entire document.

In situations where Title Company device 22 does not contain or execute PDI software, recognition and/or authentication can be performed by resurfacing at Step S122 in FIG. 3. First, the Title Company prints a paper copy of buyer-signed document snapshot 46 which was embedded in an email or other type of electronic message received by the Title Company. OCR software on Title Company device 22 can be used to scan PDI stamps 40 on the paper copy of the buyer-signed document. The OCR software controls a scanner machine communicatively coupled to Title Company device 22 or an electronic camera on Title Company device 22 to scan the PDI stamps 40 on the paper copy. The OCR software extracts web links (e.g., a URLs) encoded in PDI stamps 40 and uses the links to view (or download) buyer-signed document snapshot 46 from server 26. This resurfacing process allows the Title Company to compare the paper copy with the buyer-signed document snapshot 46 and verify that the property address and any other transaction terms are the same on both documents.

Next, when the Title Company is satisfied as to the source and accuracy of information on the document obtained via the electronic message it received, the Title Company prepares a preliminary title report on the property specified on the document.

### EXAMPLE F

In an example, the Title Company and the Buyer's Agent use the persistent data integrity system and method of the present invention. The method is performed according to Section F in FIG. 3. In this example, persistent data integrity system 10 may comprise Buyer's Agent device 14 (and optionally Title Company device 22 and/or server 26).

Section F may continue from Section E of FIG. 3. At Step S124 in Section F, preliminary title report 56 is sent by the Title Company to the Buyer's Agent. Preliminary title report 56 can be sent by postal service, courier, fax, email, or other method. Title Company device 22 can be used to send preliminary title report 56 by email to the Buyer's Agent.

At Step S126 of FIG. 3, the Buyer's Agent may import an electronic copy of preliminary title report 56 into system 10 which allows it to be stored by server 26 into memory. For example, the Buyer's Agent can feed a paper copy of preliminary title report 56 (e.g., a fax paper copy, or a paper copy received by postal or courier service) into a scanner machine communicatively coupled to Buyer's Agent device 14 to create the electronic copy to be imported into system 10. Alternatively, the Buyer's Agent can use Buyer's Agent device 14 to download the electronic copy from an email or other type of electronic message from the Title Company which was received by the Buyer's Agent. Buyer's Agent device 14 transmits the electronic copy of the preliminary title report to server 26. Based on the PDI stamps present on the electronic copy, server 26 associates the stored preliminary title report with the Purchase Agreement of any of FIGS. 2C to 2E.

### EXAMPLE G

In an example, the Buyer's Agent and the Seller use the persistent data integrity system and method of the present invention. The method is performed according to Section G in FIG. 3. In this example, persistent data integrity system 10 may comprise Buyer's Agent device 14 and Buyer's device 16 (and optionally server 26).

Section G may continue from Section F. In Section G, Buyer's Agent reviews the preliminary title report. The Buyer's Agent may tell the Buyer that conditions in preliminary title report are satisfactory. At Step S128 of FIG. 3, the Buyer's Agent forwards a set of document snapshots to the Buyer. The set of document snapshots includes snapshot 58 of a document on which Buyer can indicate approval of title (or other due diligence conditions) based on the preliminary title report (or a property inspection report). Due diligence approval document snapshot 58 has embedded in it PDI stamp 40 which is associated by server 26 with PDI stamps 40 on seller-signed document snapshot 54. Optionally, the set of document snapshots further includes seller-signed document snapshot 54.

At Step S126 of FIG. 3, Buyer's Agent forwards to the Buyer the set of document snapshots 60 (which includes due diligence approval document snapshot 58 and optionally seller-signed document 54) by executing a second submit command on Buyer's Agent device 14. (The first submit command was executed to forward unsigned document snapshot 38 in FIG. 2C to the Buyer.) Server 26 stores metadata related to the second submit command from Buyer's Agent device 14. Such metadata (called “second submission metadata”) include without limitation one or a combination of the date and time of the second submission, IP address of Buyer's Agent device 14, and the recipient information in the Buyer's second submit command. Server 26 associates due diligence approval document snapshot 58 (and optionally seller-signed document 54) with the second submission metadata. Server 26 optionally associates particular PDI stamp 40 on due diligence approval document snapshot 58 with the second submission metadata. The association can be accomplished with a lookup table or similar data structure maintained by server 26 and stored in memory.

At Step S128 of FIG. 3, the set of document snapshots 60 (which includes due diligence approval document snapshot 58 and optionally seller-signed document 54) is transmitted by server 26 and/or Buyer's Agent device 14 through network 12 to Buyer's device 16. For example, the set of document snapshots 60 can be transmitted by server 26 and/or Buyer's Agent device 14 as an attachment in an email or other type of electronic message to the Buyer's email address, mobile telephone number, or other type of messaging account registered to the Buyer. Alternatively, server 26 and/or Buyer's Agent device 14 sends an email or other type of electronic message which contains a link or multiple links to the set of document snapshots 60. Each link can be a web address or a hyperlink that encodes a web address. For example, the link can be a uniform resource locator (URL) that is unique to seller-signed document snapshot 54. There can be one URL for the set of document snapshots 60 or multiple URLs for various pages of the snapshots 60.

The Buyer can use Buyer's device 16 to access the Buyer's account and retrieve the set of document snapshots 60. PDI stamps 40 on the set of document snapshots 60 allow Buyer's device 16 to recognize document snapshots 60 as being the correct document and/or authenticate document snapshots 60 as having come from the Buyer's Agent. Recognition and/or authentication can be performed by one or more modules of the PDI software (executed on server 26 and/or Buyer's device 16) which processes the PDI stamps and the second submission metadata. For example, the PDI software can cause server 26 to transmit to Buyer's device 16 the specific values (e.g., numbers, text, and/or check marks) for transaction terms which should appear on document snapshots 60 received by the Buyer. The PDI software optionally causes Buyer's device 16 to display those values to allow the Buyer to make a visual comparison. Those values can be displayed as part of an abstract of document specific content in addition to or as an alternative to displaying the entire document.

At Step S130 of FIG. 3, after the Buyer reads the information in the set of signed document snapshots 60 and confirms their accuracy, the Buyer applies second electronic signature 62 and optionally additional data, such as date 64, to due the diligence approval document. Second electronic signature 62 and any other data are applied by the Buyer to the due diligence approval document snapshot using Buyer's device 16 executing persistent data integrity (PDI) software. The Buyer's second electronic signature 62 and any other data indicate that due diligence conditions (e.g., property inspection conditions and title conditions) are satisfactory to the Buyer. This creates signed document snapshots 66 for the purchase transaction, as shown in FIG. 2F.

Referring to FIG. 2F and Step S132 of FIG. 3, signed document snapshots 66 (which include signed versions of the due diligence approval document and the purchase agreement) are stored by server 26 in memory. Embedded within signed document snapshots 66 are: preexisting text 32; transaction terms 36; PDI stamps 40; the Buyer's first electronic signature 42 and other data 44 (if any) applied by the Buyer to the Purchase Agreement; the Seller's signature 50 and other data 52 (if any) applied by the Seller to the Purchase Agreement; and the Buyer's second electronic signature 62 and other data 64 (if any) applied by the Buyer to the due diligence approval document.

Server 26 stores metadata (called “second registration metadata”) generated with application of the Buyer's second electronic signature 62. Server 26 associates signed document snapshots 66 with the second registration metadata. Server 26 associates the particular PDI stamps 40 of signed document snapshots 66 with the second registration metadata. The association can be accomplished with a lookup table or similar data structure maintained by server 26 and stored in memory. The second registration metadata include without limitation any one or a combination of the types of metadata previously listed for the Sellers first electronic signature 44 in FIG. 2D.

In Example G, Buyer's device 16 can be a first client communication device has added document specific content (e.g., Buyer's signature 62) to a document. Buyer's Agent device 16 can be a second client communication device that receives from server 26 a response that includes any one or more of: the image of the document, an abstract of document specific content that was added to the document by the first client communication device, and a link that enables the second client communication device to retrieve the image of the document.

### EXAMPLE H

In an example, a Third Party uses the persistent data integrity system and method of the present invention. The method is performed according to Section H in FIG. 3. In this example, persistent data integrity system 10 may comprise Buyer's Agent device 14 and Buyer's device 16 (and optionally server 26).

Section H may continue from Section G of FIG. 3. At Step S134 in Section H, the Buyer's Agent uses Buyer's Agent device 14 to instruct server 26 to transmit signed document snapshots 66 of FIG. 2F to Third Party device 22. In the context of a property purchase transaction, the Third Party can be a bank or escrow entity, and signed document snapshot 66 would allow the bank or escrow entity to proceed with the transaction. At Step S136 of FIG. 3, PDI stamps 40 on signed document snapshots 66, second submission metadata, and/or second registration metadata allow Third Party device 22 to recognize signed document snapshots 66 as being the correct documents and/or authenticate signed document snapshots 66 as having come from the two parties of the transaction (e.g., the Buyer and Seller). Recognition and/or authentication can be performed by one or more modules of the PDI software (executed on server 26 and/or Third Party device 22) which process the PDI stamps and/or submission metadata and/or registration metadata.

In situations where Third Party device 24 does not contain or execute PDI software, recognition and/or authentication can be performed by resurfacing at Step S136 of FIG. 3. First, the Third Party (e.g., a bank or escrow entity) prints a paper copy of signed document snapshots 66 which was embedded in an email or other type of electronic message received by the Third Party.

OCR software on Third Party device 24 can be used to scan PDI stamps 40 on the paper copy of signed document snapshots 66 (FIG. 2D). The OCR software controls a scanner machine communicatively coupled to Third Party device 24 or an electronic camera on Third Party device 24 to scan the PDI stamps 40 on the paper copy. The OCR software extracts web links (e.g., a URLs) encoded in PDI stamps 40 and uses the links to view (or download) signed document snapshots 66 from server 26. This resurfacing process allows the Third Party (e.g., a bank or escrow entity) to compare the paper copy with signed document snapshots 66 and to verify that information, such as transaction terms, are accurate and are same on both documents. Alternatively or additionally, the resurfacing process can allow the Third Party to authenticate signed document snapshots 66 attached to the electronic message it received as having come from the two parties of the transaction (e.g., the Buyer and Seller) based on second submission meta data and second registration metadata associated the PDI stamps on the surface of the paper copy.

In another example for verifying data integrity, server 26 can look up the code in the PDI stamps of the documents in question (e.g., signed document snapshots 66 in this Example) and tries to match it to a code of another PDI stamp that was previously stored by server 26 into memory. If a match is made, Third Party device 24 receives from server 26 a response that would allow the Third party to verify the integrity of signed document snapshots 66 that it has received. The response from the server can include any of the image of the particular documents associated with the PDI stamp code that was previously stored by server 26, an abstract of document specific content in that particular document, and a link that enables the Third Party device 24 to retrieve the image of that particular document.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

1. A system for communicating document data between client communication devices, the system comprising:
a server configured to store an image of a document and configured to add a machine-readable stamp on the image of the document, the document having been generated by a first client communication device, wherein the stamp is visible when the image of the document is viewed, and the stamp includes or encodes a code unique to the document, and
the server is further configured to transmit to a second client communication device a response to a request from the second client communication device, wherein the response includes any one or more of: the image of the document, an abstract of document specific content within the document, and a link that enables the second client communication device to retrieve the image of the document.

2. The stent of claim 1, wherein the stamp is a bar code, and the bar code is visible when the image of the document is displayed on a display screen and when the image of the document is printed on paper.

3. The system of claim 1, wherein the server is configured to store in memory the code in the stamp and is configured to associate the document with the code in the stamp, and
wherein the request from the second client device includes the code, and
wherein the server is configured to match the code in the request to the code previously stored by the server, and to transmit the response based on the match between the code in the request to the code previously stored by the server, the response including an image, abstract, or link for the document associated with the code previously stored by the server.

4. The system of claim 1, wherein the response includes the image of the document.

5. The system of claim 1, wherein the document includes document specific content added to the document by the first client communication device, the response to the second client communication device includes an abstract of the document specific content that was added to the document by the first client communication device, and the abstract excludes the image of the document.

6. The system of claim 1, wherein the response includes a link that includes or encodes a universal resource locator for the image of the document, and wherein
the server is configured to transmit the image of the document to the second client communication device in response to a request directed by the second client communication device to the universal resource locator.

7. A method for communicating document data between client communication devices, the method comprising:
storing an image of a document generated by a first client communication device, the image including document specific content added to the document by the first client communication device;
adding a machine-readable stamp on the image of the document, wherein the stamp is visible when the image of the document is viewed, and the stamp includes or encodes a code unique to the document; and
transmitting to a second client communication device a response to a request from the second client communication device, wherein the response includes any one or more of: the image of the document, an abstract of document specific content within the document, and a link that enables the second client communication device to retrieve the image of the document.

8. The method of claim 7, wherein the stamp includes a bar code, and the bar code is visible when the image of the document is displayed on a display screen and when the image of the document is printed on paper.

9. The method of claim 7, further comprising:
storing into memory the code in the stamp;
associating the document with the code in the stamp; followed by
receiving the request from the second client communication device, wherein the request includes a code;
in response to the received request, matching the code in the request with the code stored in memory; and
transmitting the response based on matching the code in the request with the code stored in memory, the response including an image, abstract, or link for the document associated with the code stored in memory.

10. The method of claim 9, wherein the code in the request from the second client communication device is derived from a machine readable stamp on a paper copy of the image of the document that was stored.

11. The method of claim 7, within the response includes a link that includes or encodes a universal resource locator for the image of the document, and
wherein the method further comprises transmitting the image of the document to the second client communication device in response to a request directed to the universal resource locator by the second client communication device.

12. The method of claim 7, wherein the response includes the image of the document.

13. The method of claim 7, wherein the response to the second client communication device includes an abstract of the document specific content that was added to the document by the first client communication device, and the abstract excludes the image of the document.

14. A non-transitory computer readable medium having a stored computer program embodying instructions, which when executed by a computer, causes the computer to communicate document data, the computer readable medium comprising:
instructions to store an image of a document, the document having been generated by a first client communication device, the image including document specific content added to the document by the first client communication device;
instructions to add a machine-readable stamp on the image of the document, wherein the stamp is visible when the image of the document is viewed and the stamp includes or encodes a code unique to the document; and
instructions to transmit to a second client communication device a response to a request from the second client communication device, wherein the response includes any one or more of: the image of the document, an abstract of the document specific content that was added to the document by the first client communication device, and a link that enables the second client communication device to retrieve the image of the document.

15. The computer readable medium of claim 14, further comprising:
instructions to store into memory the code in the stamp when storing the image of the document;
instructions to associate the document with the code in the stamp;
instructions for receiving the request from the second client communication device, wherein the request includes a code;
instructions for matching, in response to the received request, the code in the request with a code previously stored in memory; and
instructions to transmit the response based on matching the code in the response with the code previously stored in memory, the response including an image, abstract, or link for the document associated with the code previously stored in memory.

16. The computer readable medium of claim 14, wherein the instructions to add a machine-readable stamp on the image of the document includes instructions to add a bar code on the image of the document, and the bar code is visible when the image of the document is displayed on a display screen and when the image of the document is printed on paper.

17. The computer readable medium of any one of claim 14, wherein the instructions to transmit a response to the second client communication device includes instructions to transmit a link as part of the response, wherein the link includes or encodes a universal resource locator for the image of the document, and
wherein the computer readable medium further comprises instructions to transmit the image of the document in response to a request directed to the universal resource locator by the second client communication device.

18. The computer readable medium of claim 14, wherein the instructions to transmit to a response to the second client communication device includes instructions to transmit the image of the document as part of the response.

19. The computer readable medium of claim 14, within the instructions to transmit to a response to the second client communication device includes instructions to transmit an abstract as part of the response, wherein the abstract includes the document specific content that was added to the document by the first client communication device, and the abstract excludes the image of the document.
